(19) United States
(12) Patent Application Publication
(10) Pub. No.: US 2004/0215532 A1
(43) Pub. Date: Oct. 28, 2004

(54) Method and system for monitoring relative movement of maritime containers and other cargo

(76) Inventors: Hans Boman, Stockholm (SE); Eric Sandberg, Knivsta (SE)

Correspondence Address: JENKENS & GILCHRIST, PC, 1445 ROSS AVENUE, SUITE 3200, DALLAS, TX, 75202, US

(21) Appl. No.: 10/786,633

(22) Filed: Feb. 25, 2004

Related U.S. Application Data
(63) Continuation-in-part of application No. 10/667,282, filed on Sep. 17, 2003.
(60) Provisional application No. 60/449,406, filed on Feb. 25, 2003.

(51) Int. Cl. G06F 17/60

(52) U.S. Cl. 705/28

(57) ABSTRACT

A container and cargo movement monitoring system includes a device, a reader, and a server. The reader includes means for transmitting and receiving information, an internal signal receiver for receiving indicators, from a device, related to at least one of a position and a change in position of a particular piece of cargo to which the device is affixed, and means for logging position based data of the particular piece of cargo. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims.

### CROSS-REFERENCES TO RELATED APPLICATIONS

This Application for Patent claims priority from, and hereby incorporates by reference for any purpose the entire disclosure of, co-pending Provisional Patent Application No. 60/449,406 filed Feb. 25, 2003. This Application is a Continuation-in-Part of, and hereby incorporates by reference for any purpose the entire disclosure of, co-pending U.S. patent application No. 10/667,282, filed Sep. 17, 2003.

### BACKGROUND

1. Technical Field

The present invention relates to a method of and system for monitoring the movement of a freight container and tracking its location and, more particularly, but not by way of limitation, to a method of and system for monitoring the relative movement of containers or other large shipborne cargo aboard a vessel to monitor movements of containers.

2. History of the Related Art

The vast majority of goods shipped throughout the world are shipped via what are referred to as intermodal freight containers. As used herein, the term “containers” includes any container (whether with wheels attached or not) that is not transparent to radio frequency signals, including, but not limited to, intermodal freight containers. The most common intermodal freight containers are known as International Standards Organization (ISO) dry intermodal containers, meaning they meet certain specific dimensional, mechanical and other standards issued by the ISO to facilitate global trade by encouraging development and use of compatible standardized containers, handling equipment, ocean-going vessels, railroad equipment and over-the-road equipment throughout the world for all modes of surface transportation of goods. There are currently more than 12 million such containers in active circulation around the world as well as many more specialized containers such as refrigerated containers that carry perishable commodities and tank containers that carry liquids. The United States alone receives approximately six million loaded containers per year, or approximately 17,000 per day, representing nearly half of the total value of all goods received each year.

Since approximately 90% of all goods shipped internationally are moved in containers, container transport has become the backbone of the world economy. The sheer volume of containers transported worldwide renders individual physical inspection impracticable, and only approximately 2% to 3% of containers entering the United States are actually physically inspected. Risk of introduction of a terrorist biological, radiological or explosive device via a freight container is high, and the consequences to the international economy of such an event could be catastrophic, given the importance of containers in world commerce.

Even if sufficient resources were devoted in an effort to conduct physical inspections of all containers and their contents, such an undertaking would result in serious economic consequences. The time delay alone could, for example, cause the shut down of factories and undesirable and expensive delays in shipments of goods to customers.

Current container designs fail to provide adequate mechanisms for establishing and monitoring the security of the containers or their contents. A typical container includes one or more door hasp mechanisms that allow for the insertion of a plastic or metal indicative “seal” or bolt barrier conventional “seal” to secure the doors of the container. The door hasp mechanisms that are conventionally used are very easy to defeat, for example, by drilling an attachment bolt of the hasp out of a door to which the hasp is attached. The conventional seals themselves currently in use are also quite simple to defeat by use of a common cutting tool and replacement with a rather easily duplicated seal.

A more advanced solution proposed in recent time is an electronic seal (“e-seal”). These e-seals are equivalent to traditional door seals and are applied to the containers via the same, albeit weak, door hasp mechanism as an accessory to the container, but include an electronic device such as a radio or radio reflective device that can transmit the e-seal's serial number and a signal if the e-seal is cut or broken after it is installed. However, the e-seal is not able to communicate with the interior or contents of the container and does not transmit information related to the interior or contents of the container to another device. Moreover, once an e-seal is cut it simply falls off the container door hasp and can be of no further utility.

The e-seals typically employ either low power radio transceivers or use radio frequency backscatter techniques to convey information from an e-seal tag to a reader installed at, for example, a terminal gate. Radio frequency backscatter involves use of a relatively expensive, narrow band high-power radio technology based on combined radar and radio-broadcast technology. Radio backscatter technologies require that a reader send a radio signal with relatively high transmitter power (i.e., 0.5-2W) that is reflected or scattered back to the reader with modulated or encoded data from the e-seal.

In addition, e-seal applications currently use completely open, unencrypted and insecure air interfaces and protocols allowing for relatively easy hacking and counterfeiting of e-seals. Current e-seals also operate only on locally authorized frequency bands below 1 GHz, rendering them impractical to implement in global commerce involving intermodal containers since national radio regulations around the world currently do not allow their use in many countries.

Furthermore, the e-seals are not effective at monitoring security of the containers from the standpoint of alternative forms of intrusion or concern about the contents of a container, since a container may be breached or pose a hazard in a variety of ways since the only conventional means of accessing the inside of the container is through the doors of the container. For example, a biological agent could be implanted in the container through the container's standard air vents, or the side walls of the container could be cut through to provide access. Although conventional seals and the e-seals afford one form of security monitoring the door of the container, both are susceptible to damage. The conventional seal and e-seals typically merely hang on the door hasp of the container, where they are exposed to physical damage during container handling such as ship loading and unloading. Moreover, conventional seals and e-seals cannot monitor the contents of the container and are not able to interface with or (since containers are manufactured from steel that is opaque to radio signals) transmit data to the outside world from other sensors which may be placed in the interior of the container such as, for example, temperature, light, combustible gas, motion, or radioactivity sensors (without modifying the container door or wall).

In addition to the above, the monitoring of the integrity of containers via door movement can be relatively complex. Although the containers are constructed to be structurally sound and carry heavy loads, both within the individual containers as well as by virtue of containers stacked upon one another, each container is also designed to accommodate transverse loading to accommodate dynamic stresses and movement inherent in (especially) ocean transportation and which are typically encountered during shipment of the container. Current ISO standards for a typical container may allow movement of container door panels on a vertical axis due to transversal loads by as much as 40 millimeters relative to one another. Therefore, security approaches based upon maintaining a tight interrelationship between the physical interface between two container doors are generally not practicable.

Containerized and other cargo on shipping vessels (e.g., trains, tractor-trailer rigs, ocean-going vessels, etc.) are typically secured to other objects or pieces of cargo. For example, on an ocean-going vessel, cargo is secured in holds or on the deck in racks and then lashed to the racking and/or decks with stainless steel marine lashings. Containers are further secured to each other in stacks by the use of twist lock mechanisms. Such measures are to be taken to prevent containers or other cargo from shifting during the voyage, which in extreme cases can cause the loss of the containers or other cargo overboard in rough seas when the ship is pitching and rolling, or cause the ship itself to be in danger of sinking because of cargo and ballast imbalances.

### SUMMARY OF THE INVENTION

The present invention relates to systems and methods of monitoring relative movement of cargo aboard a shipping vessel. More particularly, one aspect of the invention includes a reader for monitoring the movement of cargo. The reader includes means for transmitting and receiving information at the reader, an internal signal receiver for receiving indicators, from a device, related to at least one of a position and a change in position of a particular piece of cargo to which the device is affixed, and means for logging positions of the particular piece of cargo.

In another aspect, the present invention relates to a server for monitoring movement of cargo. The server includes means for storing a data map representing a position of each piece of cargo, means for receiving indicators from at least one reader, said indicators representing a current position or directional vector for a particular piece of cargo, and means for determining, based on the data map and the received indicators, whether a particular piece of cargo has moved beyond a predetermined threshold.

In another aspect, the present invention relates to a method of monitoring movement of cargo on a shipping vessel. The method includes determining a data map, based on at least one of a Received Signal Strength Indicator (RSSI), a Time Difference Of Arrival (TDOA) value, and an Angle Of Arrival (AOA) value, including a position or change in position for each piece of cargo prior to moving the shipping vessel, monitoring a position of each piece of cargo during movement of the shipping vessel, and providing an alarm if a piece of cargo moves beyond a predetermined threshold.

### BRIEF DESCRIPTION OF DRAWINGS

A more complete understanding of exemplary embodiments of the present invention can be achieved by reference to the following Detailed Description of Exemplary Embodiments of the Invention when taken in conjunction with the accompanying Drawings, wherein:

FIG. 1A is a diagram illustrating communication among components of a system according to an embodiment of the present invention;

FIG. 1B is a diagram illustrating an exemplary supply chain;

FIG. 2A is a schematic diagram of a device that may be utilized in conjunction with an embodiment of the present invention;

FIG. 2B is a top view of a device that may be utilized in conjunction with an embodiment of the present invention;

FIG. 2C is a side view of a device that may be utilized in conjunction with an embodiment of the present invention;

FIG. 2D is a first perspective cut-away view of a device may be utilized in conjunction with an embodiment of the present invention;

FIG. 2E is a second perspective cut-away view of a device may be utilized in conjunction with an embodiment of the present invention;

FIG. 2F is a front view of a device may be utilized in conjunction with an embodiment of the present invention;

FIG. 2G is a back view of a device may be utilized in conjunction with an embodiment of the present invention;

FIG. 2H is a bottom view of a device may be utilized in conjunction with an embodiment of the present invention;

FIG. 2I is a top view of a device may be utilized in conjunction with an embodiment of the present invention;

FIG. 2J is a front view of the device of FIG. 2F as installed on a container;

FIG. 2K is a perspective view of the device of FIG. 2F as installed on a container;

FIG. 3A is a schematic diagram of a reader according to an embodiment of the present invention;

FIG. 3B is a diagram of a reader in accordance with the principles of the present invention;

FIG. 4 is a first application scenario of the system of FIG. 1A;

FIG. 5 is a second application scenario of the system of FIG. 1A;

FIG. 6 is a third application scenario of the system of FIG. 1A according to an embodiment of the present invention;

FIG. 7 is a fourth application scenario of the system of FIG. 1A according to an embodiment of the present invention;

FIG. 8 is a block diagram of a device in accordance with an embodiment of the present invention;

FIG. 9 is a diagram of a device and reader in a shipping environment in accordance with an embodiment of the present invention;

FIG. 10 is a diagram of a system in accordance with an embodiment of the present invention;

FIG. 11 is a diagram of a device and reader in a shipping environment in accordance with an embodiment of the present invention; and

FIG. 12 is a flow diagram of a method monitoring movement of cargo of a shipping vessel in accordance with an embodiment of the present invention.

### DETAILED DESCRIPTION OF EXEMPLARY EMBODIMENTS OF THE PRESENT INVENTION

It has been found that a device of the type set forth, shown, and described below, may be positioned in and secured to a container or other cargo such as vehicles for effective monitoring of the relative movement of the container or cargo. As will be defined in more detail below, a device in accordance with principles of the present invention is constructed for positioning within a portion of the container or a portion of the cargo. It will be understood by one skilled in the art that embodiments of the present invention are applicable to any type of shipping vessel, such as, for example, trains, tractor-trailer rigs, ocean-going vessels, and other land or air transports, as well as to shipping yards or warehouses.

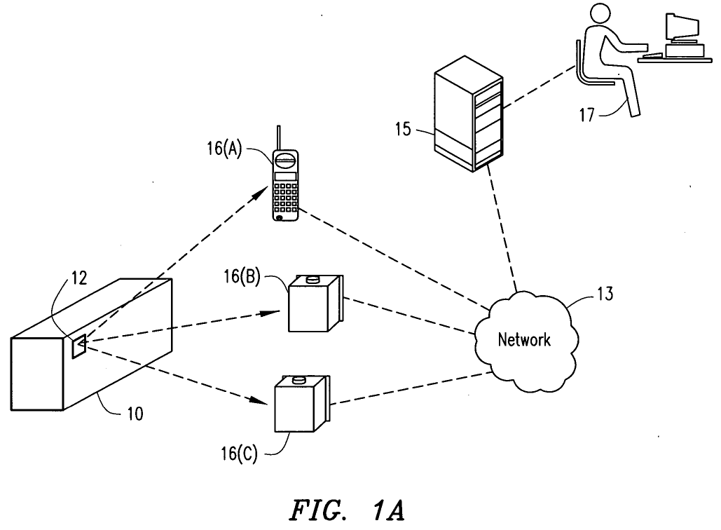

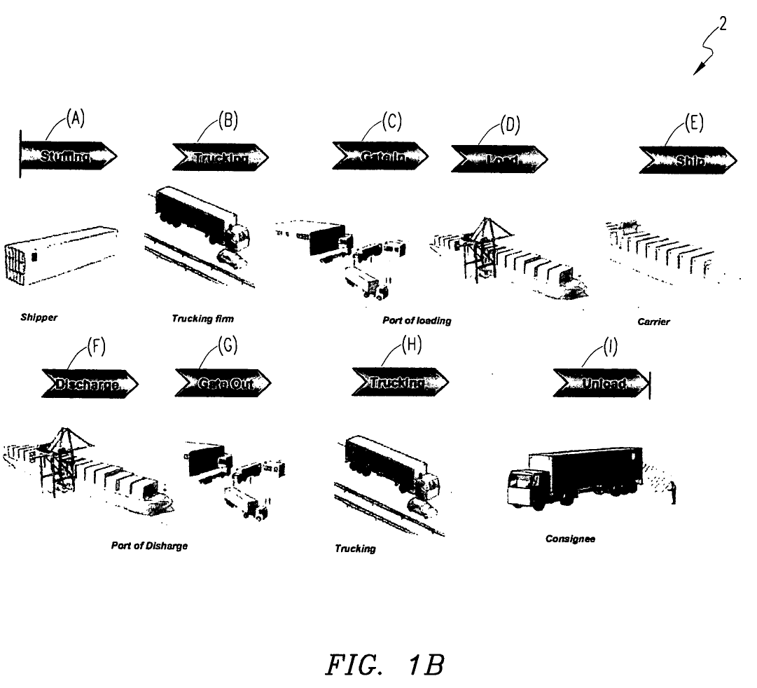

FIG. 1A is a diagram illustrating communication among components of a system in accordance with principles of the present invention. The system includes a device 12, at least one variety of reader 16, a server 15, and a software backbone 17. The device 12 may have features that ensure the container has not been breached after the container 10 has been secured. The container 10 is secured and tracked by a reader 16. Each reader 16 may include hardware or software for communicating with the server 15 such as a modem for transmitting data over GSM, CDMA, etc. or a cable for downloading data to a PC that transmits the data over the Internet to the server 15. Various conventional means for transmitting the data from the reader 16 to the server 15 may be implemented within the reader 16 or as a separate device. The reader 16 may be configured as a handheld reader 16(A), a mobile reader 16(B), or a fixed reader 16(C). The handheld reader 16(A) may be, for example, operated in conjunction with, for example, a mobile phone, a personal digital assistant, or a laptop computer. The mobile reader 16(B) is basically a fixed reader with a GPS interface, typically utilized in mobile installations (e.g., on trucks, trains, or ships using existing GPS, AIS or similar positioning systems) to secure, track, and determine the integrity of the container in a manner similar to that of the handheld reader 16(A). In fixed installations, such as, for example, those of a port or shipping yard, the fixed reader 16(C) is typically installed on a crane or gate. The reader 16 serves primarily as a relay station between the device 12 and the server 15.

The server 15 stores a record of security transaction details such as, for example, door events (e.g., security breaches, container security checks, securing the container, and disarming the container), location, as well as any additional desired peripheral sensor information (e.g., temperature, motion, radioactivity). The server 15, in conjunction with the software backbone 17, may be accessible to authorized parties in order to determine a last known location of the container 10, make integrity inquiries for any number of containers, or perform other administrative activities.

The device 12 communicates with the readers 16 via a short-range radio interface such as, for example, a radio interface utilizing direct-sequence spread-spectrum principles. The radio interface may use, for example, BLUETOOTH or any other short-range, low-power radio system that operates in the license-free Industrial, Scientific, and Medical (ISM) band, which operates around e.g. 2.4 GHz. Depending on the needs of a specific solution, related radio ranges are provided, such as, for example, a radio range of up to 100 m.

The readers 16 may communicate via a network 13, e.g. using TCP/IP, with the server 15 via any suitable technology such as, for example, Universal Mobile Telecommunications System (UMTS), Global System for Mobile Communications (GSM), Code Division Multiple Access (CDMA), Time Division Multiple Access (TDMA), Pacific Digital Cellular System(PDC), Wideband Local Area Network (WLAN), Local Area Network (LAN), Satellite Communications systems, Automatic Identification Systems (AIS), or Mobitex. The server 15 may communicate with the software backbone 17 via any suitable wired or wireless technology. The software backbone 17 is adapted to support real-time surveillance services such as, for example, tracking and securing of the container 10 via the server 15, the readers 16, and the device 12. The server 15 and/or the software backbone 17 are adapted to store information such as, for example, identification information, tracking information, door events, and other data transmitted by the device 12 and by any additional peripheral sensors interoperably connected to the device 12. The software backbone 17 also allows access for authorized parties to the stored information via a user interface that may be accessed via, for example, the Internet.

Referring now to FIG. 1B, there is shown a diagram illustrating a flow 2 of an exemplary supply chain from points (A) to (I). Referring first to point (A), a container 10 is filled with cargo by a shipper or the like. At point (B), the loaded container is shipped to a port of embarkation via highway or rail transportation. At point (C), the container is gated in at the port of loading such as a marine shipping yard.

At point (D), the container is loaded on a ship operated by a carrier. At point (E), the container is shipped by the carrier to a port of discharge. At point (F), the container is discharged from the ship. Following discharge at point (F), the container is loaded onto a truck and gated out of the port of discharge at point (G). At point (H), the container is shipped via land to a desired location in a similar fashion to point (B). At point (I), upon arrival at the desired location, the container is unloaded by a consignee.

As will be apparent to those having ordinary skill in the art, there are many times within the points of the flow 2 at which security of the container could be compromised without visual or other conventional detection. In addition, the condition of the contents of the container could be completely unknown to any of the parties involved in the flow 2 until point (H) when the contents of the container are unloaded.

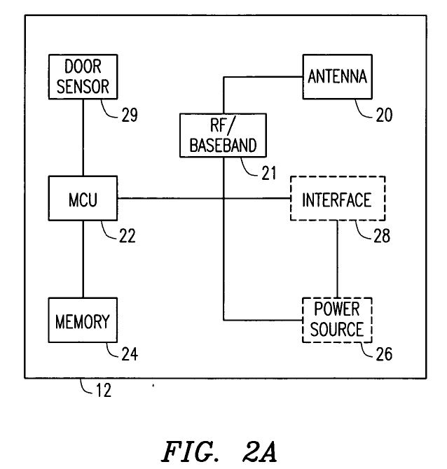

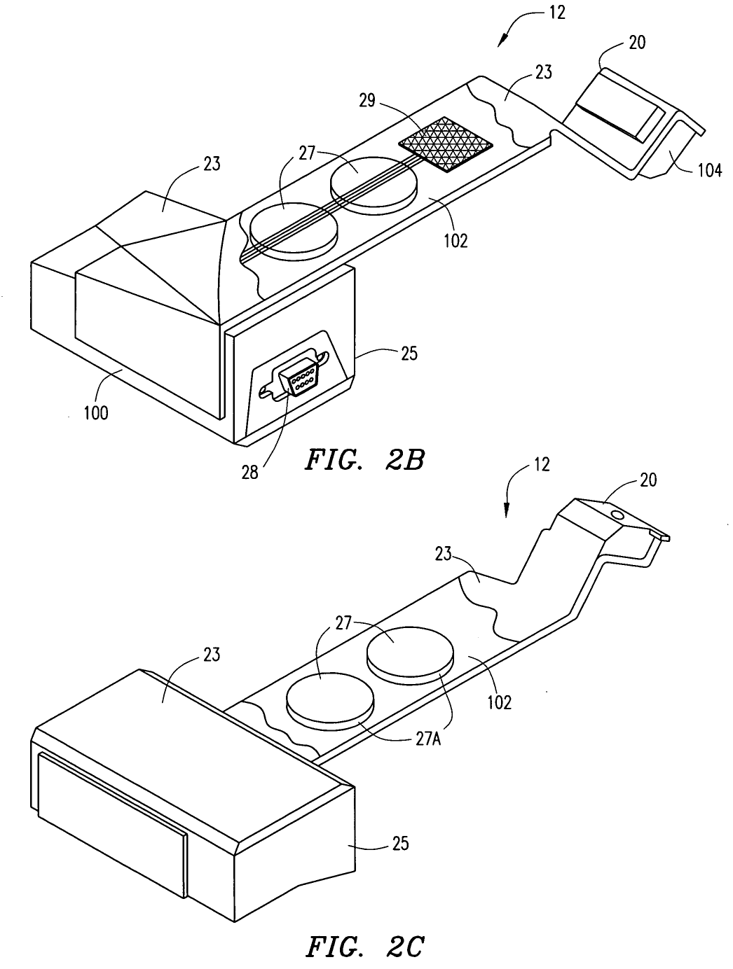

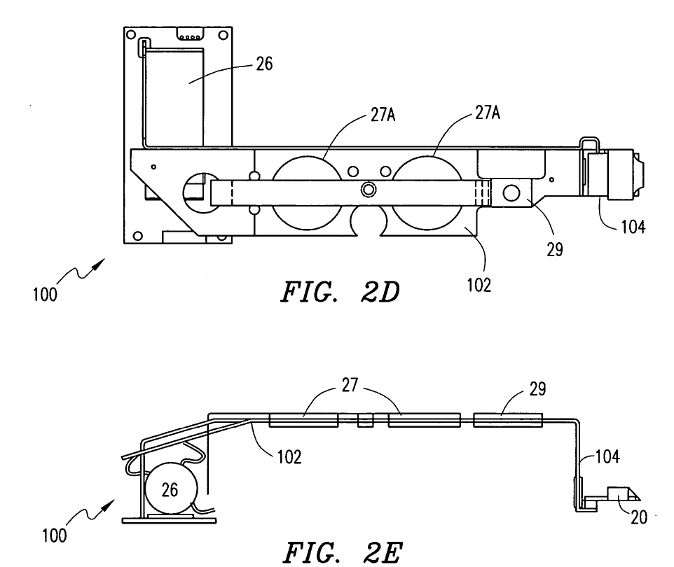

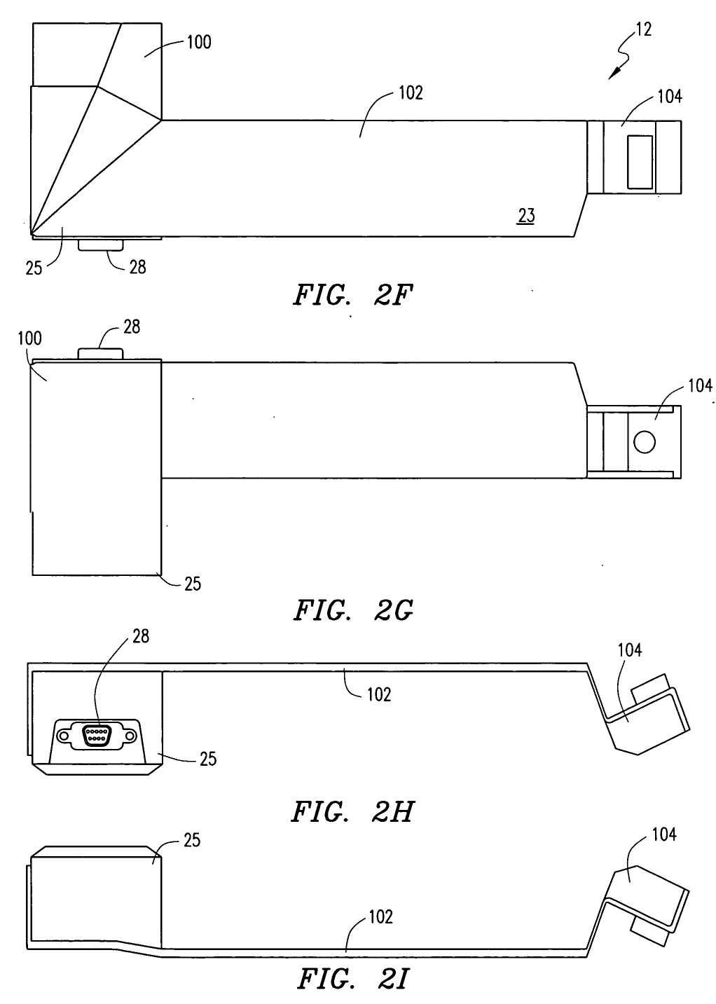

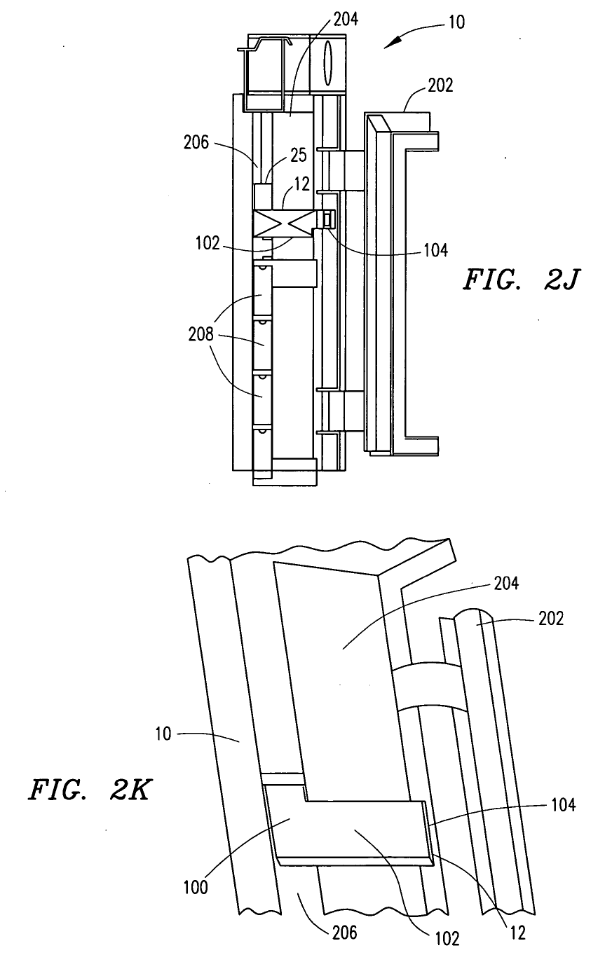

FIG. 2A is a block diagram of the device 12. The device 12 includes an antenna 20, an RF/baseband unit 21, a microprocessor (MCU) 22, a memory 24, and a door sensor 29. The device 12 may also include an interface 28 for attachment of additional sensors to monitor various internal conditions of the container such as, for example, temperature, vibration, radioactivity, gas detection, and motion. The device 12 may also include an optional power source 26 (e.g., battery); however, other power arrangements that are detachable or remotely located may also be utilized by the device 12. When the power source 26 includes a battery (as shown herein), inclusion of the power source 26 in the device 12 may help to prolong battery life by subjecting the power source 26 to smaller temperature fluctuations by virtue of the power source 26 being inside the container 10. The presence of the power source 26 within the container 10 is advantageous in that the ability to tamper with or damage the power source 26 is decreased. The device 12 may also optionally include a connector for interfacing directly with the reader 16. For example, a connector may be located on an outer wall of the container 10 for access by the reader 16. The reader 16 may then connect via a cable or other direct interface to download information from the device 12.

The microprocessor 22 (equipped with an internal memory) discerns door events from the door sensor 29, including, for example, container-security requests, container-disarming requests, and container-security checks. The discerned door events also include security breaches that may compromise the contents of the container 10, such as opening of a door after the container 10 has been secured. The door events may be time-stamped and stored in the memory 24 for transmission to the reader 16. The door events may be transmitted immediately, periodically, or in response to an interrogation from the reader 16. The door sensor 29 shown herein is of the pressure sensitive variety, although it may be, for example, an alternative contact sensor, a proximity sensor, or any other suitable type of sensor detecting relative movement between two surfaces. The term pressure sensor as used herein thus includes, but is not limited to, these other sensor varieties.

The antenna 20 is provided for data exchange with the reader 16. In particular, various information, such as, for example, status and control data, may be exchanged. The microprocessor 22 may be programmed with a code that uniquely identifies the container 10. The code may be, for example, an International Standards Organization (ISO) container identification code. The microprocessor 22 may also store other logistic data, such as Bill-of-Lading (B/L), a mechanical seal number, a reader identification with a time-stamp, etc. A special log file may be generated, so that tracking history together with door events may be recovered. The code may also be transmitted from the device 12 to the reader 16 for identification purposes. The RF/baseband unit 21 upconverts microprocessor signals from baseband to RF for transmission to the reader 16.

The device 12 may, via the antenna 20, receive an integrity inquiry from the reader 16. In response to the integrity query, the microprocessor 22 may then access the memory to extract, for example, door events, temperature readings, security breaches, or other stored information in order to forward the extracted information to the reader 16. The reader 16 may also send a security or disarming request to the device 12. When the container 10 is secured by the reader 16, the MCU 22 of the device 12 may be programmed to emit an audible or visual alarm when the door sensor 29 detects a material change in pressure after the container is secured. The device 12 may also log the breach of security in the memory 24 for transmission to the reader 16. If the reader 16 sends a disarming request to the device 12, the microprocessor 22 may be programmed to disengage from logging door events or receiving signals from the door sensor 29 or other sensors interoperably connected to the device 12.

The microprocessor 22 may also be programmed to implement power-management techniques for the power source 26 to avoid any unnecessary power consumption. In particular, one option is that one or more time window(s) are specified via the antenna 20 for activation of the components in the device 12 to exchange data. Outside the specified time windows, the device 12 may be set into a sleep mode to avoid unnecessary power losses. Such a sleep mode may account for a significant part of the device operation time, the device 12 may as a result be operated over several years without a need for battery replacement.

In particular, the device 12 may utilize a “sleep” mode to achieve economic usage of the power source 26. In the sleep mode, a portion of the circuitry of the device 12 is switched off. For example, all circuitry may be switched off except for the door sensor 29 and a time measurement unit (e.g., a counter in the microprocessor 22) that measures a sleep time period tₛₗₑₑₚ. In a typical embodiment, when the sleep time period has expired or when the door sensor 29 senses a door event, the remaining circuitry of the device 12 is powered up.

When the device 12 receives a signal from the reader 16, the device 12 remains active to communicate with the reader 16 as long as required. If the device 12 does not receive a signal from the reader 16, the device 12 will only stay active as long as necessary to ensure that no signal is present during a time period referred to as a radio-signal time period or “sniff period” (t_{sniff}).

Upon t_{sniff} being reached, the device 12 is powered down again, except for the time measurement unit and the door sensor 29, which operate to wake the device 12 up again after either a door event has occurred or another sleep time period has expired.

In a typical embodiment, the reader-signal time period is much shorter (e.g., by several orders of magnitude less) than the sleep time period so that the lifetime of the device is prolonged accordingly (e.g., by several orders of magnitude) relative to an “always on” scenario.

The sum of the sleep time period and the reader-signal time period (cycle time) imposes a lower limit on the time that the device 12 and the reader 16 must reach in order to ensure that the reader 16 becomes aware of the presence of the device 12. The related time period will be referred to as the passing time (tₚₐₛₛ).

However, a passing time (tp.,) is usually dictated by the particular situation. The passing time may be very long in certain situations (e.g., many hours when the device 12 on a freight container is communicating with the reader 16 on a truck head or chassis carrying the container 10) or very short in other situations (e.g., fractions of a second when the device 12 on the container 10 is passing by the fixed reader 16(C) at high speed). It is typical for all the applications that each of the devices 12 will, during its lifetime, sometimes be in situations with a greater passing time and sometimes be in situations with a lesser passing time.

The sleep time period is therefore usually selected such that the sleep time period is compatible with a shortest conceivable passing time, (t_{pass,min}). In other words, the relation

tₛₗₑₑₚ≦t_{pass,min}−t_{sniff}

should be fulfilled according to each operative condition of the device. Sleep time periods are assigned to the device in a dynamic matter depending on the particular situation of the device (e.g., within its life cycle).

Whenever the reader 16 communicates with the device 12, the reader 16 reprograms the sleep time period of the device 12 considering the location and function of the reader 16, data read from the device 12, or other information that is available in the reader 16.

For example, if the container 10 equipped with device 12 is located on a truck by a toplifter, straddle carrier, or other suitable vehicle, the suitable vehicle is equipped with the reader 16, whereas the truck and trailer are not equipped with any readers 16. It is expected that the truck will drive at a relatively-high speed past the fixed reader 16(C) at an exit of a port or a container depot. Therefore, the reader 16(C) on the vehicle needs to program the device 12 with a short sleep time period (e.g.,˜0.5 seconds).

Further ramifications of the ideas outlined above could be that, depending on the situation, the reader 16 may program sequences of sleep periods into the device 12. For example, when the container 10 is loaded onboard a ship, it may be sufficient for the device 12 to wake up only once an hour while the ship is on sea. However, once the ship is expected to approach a destination port, a shorter sleep period might be required to ensure that the reader 16 on a crane unloading the container 10 will be able to establish contact with the device 12. The reader 16 on the crane loading the container 10 onboard the ship could program the device 12 as follows: first, wake up once an hour for three days, then wake up every ten seconds.

In another scenario, the reader 16 is moving together with the device 12 and could modify the sleep time period in dependence on the geographical location. For example, it may be assumed that the device 12 on the container 10 and the reader 16 of a truck towing the container 10 may constantly communicate with each other while the container 10 is being towed. As long as the container 10 is far enough away from its destination, the reader 16 could program the device 12 to be asleep for extended intervals (e.g., one hour.) When the reader 16 is equipped with a Global Positioning System (GPS) receiver or other positioning equipment, the reader may determine when the container 10 is approaching its destination. Once the container approaches the destination, the reader 16 could program the device 12 to wake up more frequently(e.g., every second).

While the above-described power-management method has been explained with respect to the device 12 in the context of trucking of freight containers or other cargo in transportation by sea, road, rail or air, it should be understood for those skilled in the art that the above-described power-management method may as well be applied to, for example, trucking of animals, identification of vehicles for road toll collection, and theft protection, as well as stock management and supply chain management.

Referring now to FIG. 2B, there is shown a first perspective view of the device 12. The device 12 includes a housing 25 containing the data unit 100 (not shown), a support arm 102 extending therefrom, and an antenna arm 104 extending outwardly thereof in an angular relationship therewith. As will be described below, the size of the housing 25, the length of the support arm 102, and the configuration of the antenna arm 104 are carefully selected for compatibility with conventional containers. The housing 25, the support arm 102, and the antenna arm 104 are typically molded within a polyurethane material 23 or the like in order to provide protection from the environment.

Still referring to FIG. 2B, a portion of material 23 of the support arm 102 is cut away to illustrate placement of at least one magnet 27 therein and at least one door sensor 29 thereon. The magnet 27 permits an enhanced securement of the device 12 within the container as described below, while the door sensor 29 detects variations in pressure along a sealing gasket (not shown) of the container discussed below.

A second perspective view of the device 12 as illustrated in FIG. 2C, further illustrates the placement of the magnet 27 in the support arm 102. The magnet 27 is positioned within corresponding apertures 27A formed in the support arm 102 and are bonded thereto in a manner facilitating the installation of the device 12.

Now referring to FIG. 2D, a top view of the device 12 is illustrated before any of the molding material 23 has been applied. In this way, the position of the power source 26, the data unit 100, and the antenna 20 are shown more clearly. The device 12 includes the data unit 100 and power source 26, the microprocessor 22 (not shown), the memory 24 (not shown), and the optional interface 28 (not shown). The support arm 102 extends from the data unit 100 and includes the apertures 27A to house the at least one magnet 27 as well as a support surface to which the door sensor 29 is attached. Extending from the support arm 102 is the antenna arm 104 for supporting the antenna 20.

Now referring to FIG. 2E, a side view of the device 12 before any of the molding material 23 has been applied is illustrated. As shown, the support arm 102 extends upwardly and outwardly from the data unit 100. The support arm 102 is relatively thin and substantially horizontal, although other configurations are available. As more clearly indicated in FIG. 2E, the antenna arm 104 extends angularly from the support arm 102.

Referring now to FIG. 2F, there is shown a front view of the device 12 after the molding material 23 has been applied. The device 12 is illustrated with the molded material 23 that forms the housing 25 encapsulating the device 12. The molding material 23 extends from the antenna arm 104 across the support arm 102 and around the data unit 100. The particular shape and configuration shown herein is but one embodiment of the device 12 and no limitation as to the precise shape of the device 12 is suggested herein.

Referring now to FIG. 2G, there shown a back view of the device 12 according to FIG. 1A. The angular configuration of the antenna arm 104 is likewise seen in a more simplified format for purposes of illustration in FIGS. 2H and 2I, which represent bottom and top views of the device 12.

FIG. 2J illustrates a front view of the device 12 as installed on the container 10. The container 10 is shown with a door 202 of the container 10 in an open position to show the orientation of the device 12 in greater detail. The device 12 is mounted to an area adjacent to the door 202 of the container 10. The device 12 may be mounted via a magnetic connection (as previously illustrated), an adhesive connection, or any other suitable connection, on a vertical beam 204 of the container 10. As can be seen in FIG. 2J, the device 12 is mounted so that, when the door 202 is closed, the antenna arm 104 is located on the exterior of the container 10, the door sensor 29, located within the support arm 102, is directly adjacent to a portion of the door 202, and the data unit 100 is located on the interior of the container 10. The device 12 may detect, via the door sensor 29, deviations of pressure to determine whether a door event (e.g., relative and/or absolute pressure change) has occurred. The device 12 may transmit data relative to the status of the door 202 via the antenna 20 to the server 15 as previously described. In addition, the interface 28 may be connected to any number of the external sensors 208 in order to capture information relative to internal conditions of the container 10 and the information obtained via the sensor 208 transmitted to the server 15.

Remaining with FIG. 2J, the device 12 is oriented within the container 10 so that the data unit 100 is disposed within a generally C-shaped recess or channel 206. The support arm 102, including the door sensor 29, extends across the vertical beam 204 between it and a portion of the door 202. When the door 202 is closed, pressure is maintained at the door sensor 29. When the door 202 is opened, the pressure is relieved, thereby alerting the microprocessor 22 that a door event has occurred. An electronic security key stored in the memory 24 will be erased or changed to indicate a “broken” seal or tampering event.

FIG. 2K is a perspective view of the device 12 of FIG. 2D as installed on the container 10. The device 12 is shown attached to the vertical beam 204 so that the door sensor 29 (not shown) within the support arm 102 is adjacent to the vertical beam 204, the antenna arm 104 is positioned in an area of the hinge channel of the container 10, and the data unit 100 is positioned inside the C-channel 206 of the container 10. As more clearly shown herein, the antenna arm 104 protrudes from the support arm 102 to an area substantially near the hinge portion of the container 10 in order to remain on the exterior of the container 10 when the door 202 is closed.

By placing the data unit 100 on the interior of the container 10, opportunities for tampering and/or damage to the device 12 are reduced. Because the data unit 100 is disposed in the C-channel 206, even though the contents of the container 10 may shift during transport, the contents are not likely to strike or damage the device 12.

Although the device 12 is shown as a single unit including at least one sensor and an antenna 20 for communicating with the reader 16, the device 12 may be implemented as several units. For example, a light, temperature, radioactivity, etc. sensor may be positioned anywhere inside the container 10. The sensor takes readings and transmits the readings via BLUETOOTH, or any short range communication system, to an antenna unit that relays the readings or other information to the reader 16. The sensors may be remote and separate from the antenna unit. In addition, the above illustrates the device 12 as including a door sensor 29 for determining whether a security breach has occurred. However, an unlimited variety of sensors may be employed to determine a security breach in place of, or in addition to, the door sensor 29. For example, a light sensor may sense fluctuations in light inside the container 10. If the light exceeds or falls below a predetermined threshold, then it is determined a security breach has occurred. A temperature sensor, radioactivity sensor, combustible gas sensor, etc. may be utilized in a similar fashion.

The device 12 may also trigger the physical locking of the container 10. For instance, when a reader 16 secures, via a security request, the contents of the container 10 for shipment, the microprocessor 22 may initiate locking of the container 10 by energizing elecromagnetic door locks or other such physical locking mechanism. Once the container is secured via the security request, the container 10 is physically locked to deter theft or tampering.

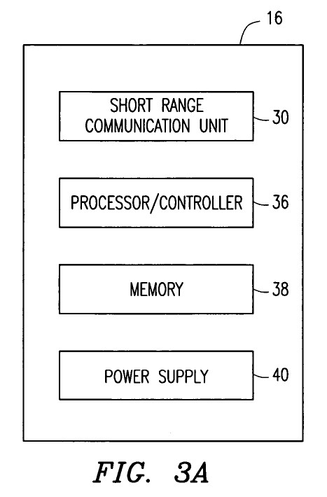

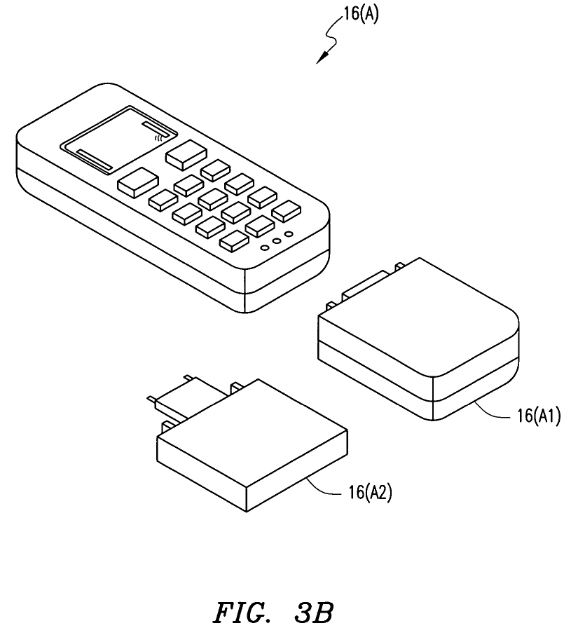

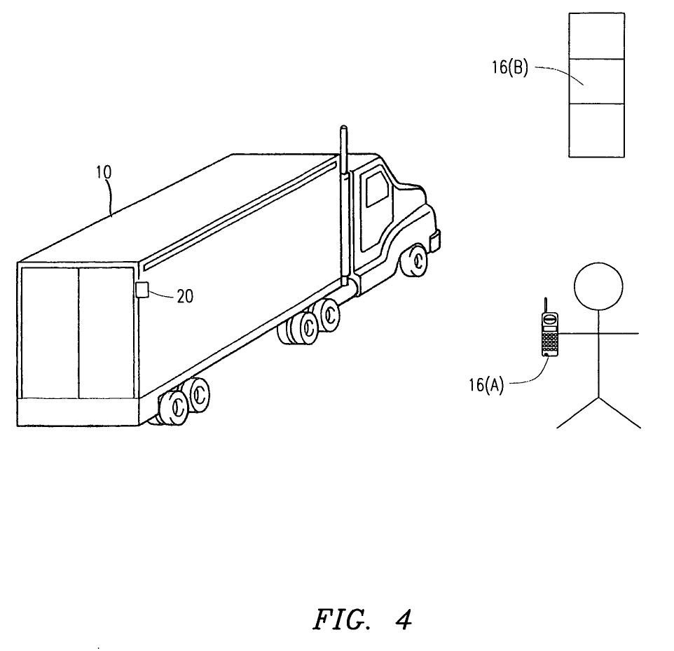

As shown in FIG. 3A, the reader 16 includes a short range antenna 30, a microprocessor 36, a memory 38, and a power supply 40. The short range antenna 30 achieves the wireless short-range, low-power communication link to the device 12 as described above with reference to FIG. 2A. The reader 16 may include or separately attach to a device that achieves a link to a remote container-surveillance system (e.g., according to GSM, CDMA, PDC, or DAMPS wireless communication standard or using a wired LAN or a wireless local area network WLAN, Mobitex, GPRS, UMTS). Those skilled in the art will understand that any such standard is non-binding for the present invention and that additional available wireless communications standards may as well be applied to the long range wireless communications of the reader 16. Examples include satellite data communication standards like Inmarsat, Iridium, Project 21, Odyssey, Globalstar, ECCO, Ellipso, Tritium, Teledesic, Spaceway, Orbcom, Obsidian, ACeS, Thuraya, or Aries in cases where terrestrial mobile communication systems are not available.

The reader 16 may include or attach to a satellite positioning unit for positioning of a vehicle on which the container 10 is loaded. For example, the reader 16 may be the mobile reader 16(B) attached to a truck, ship, or railway car. The provision of the positioning unit is optional and may be omitted in case tracking and positioning of the container 10 is not necessary. For instance, the location of the fixed reader 16(C) may be known; therefore, the satellite positioning information would not be needed. One approach to positioning could be the use of satellite positioning systems (e.g., GPS, GNSS, or GLONASS). Another approach could be the positioning of the reader 16 utilizing a mobile communication network. Here, some of the positioning techniques are purely mobile communication network based (e.g., EOTD) and others rely on a combination of satellite and mobile communication network based positioning techniques (e.g., Assisted GPS).

The microprocessor 36 and the memory 38 in the reader 16 allow for control of data exchanges between the reader 16 and the device 12 as well as a remote surveillance system as explained above and also for a storage of such exchanged data. Necessary power for the operation of the components of the reader 16 is provided through a power supply 40.

FIG. 3B is a diagram of a handheld reader 16(A). The handheld reader 16(A) is shown detached from a mobile phone 16(A1). The handheld reader 16(A) communicates (as previously mentioned) with the device 12 via, for example, a short-range direct sequence spread spectrum radio interface. Once the handheld reader 16(A) and the device 12 are within close range of one another (e.g., <100 m), the device 12 and the handheld reader 16(A) may communicate with one another. The handheld reader 16(A) may be used to electronically secure or disarm the container via communication with the device 12. The handheld reader 16(A) may also be used to obtain additional information from the device 12 such as, for example, information from additional sensors inside the container 10 or readings from the door sensor 29.

The handheld reader 16(A) shown in FIG. 3B is adapted to be interfaced with a mobile phone shown as 16(A1) or PDA. However, as will be appreciated by those having skill in the art, the handheld reader 16(A) may be a standalone unit or may also be adapted to be interfaced with, for example, a personal digital assistant or a handheld or laptop computer. The reader 16 draws power from the mobile phone and utilizes Bluetooth, or any similar interface, to communicate with the mobile phone.

Additional application scenarios for the application of the device 12 and reader 16 will now be described with respect to FIGS. 4-7. Insofar as the attachment and detachment of the reader 16(B) to different transporting or transported units is referred to, any resolvable attachment is well covered by the present invention (e.g., magnetic fixing, mechanic fixing by screws, rails, hooks, balls, snap-on mountings, further any kind of electrically achievable attachment, e.g., electro magnets, or further reversible chemical fixtures such as adhesive tape, scotch tape, glue, pasted tape).

FIG. 4 shows a first application scenario of the device 12 and the reader 16. As shown in FIG. 4, one option related to road transportation is to fix the reader 16 to the gate or a shipping warehouse or anywhere along the supply chain. In such a case, the reader 16 may easily communicate with the device 12 of the container 10 when being towed by the truck when exiting the shipping area. Another option is to provide the reader 16 as a handheld reader 16(A) as described above and then either scan the device 12 as the truck leaves the area or carry the hand-held reader 16(A) within the cabin of the truck during surveillance of the container 10.

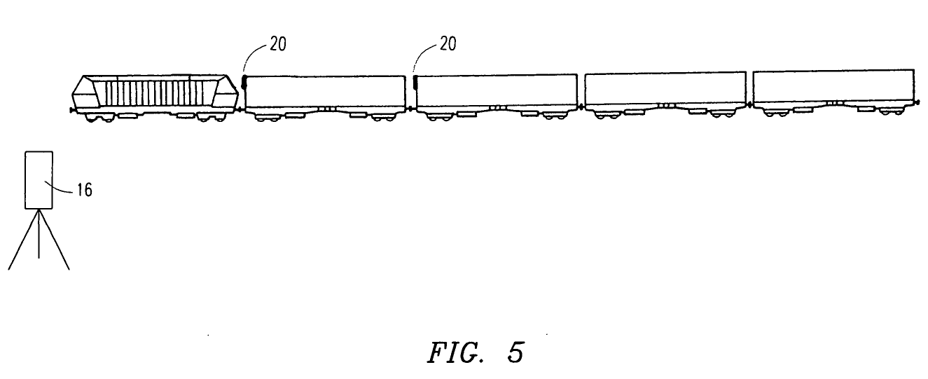

FIG. 5 shows a second application scenario for the device 12 and the reader 16 as related to rail transportation. In particular, FIG. 5 shows a first example where the reader 16 is attachably fixed along the rail line for short-range wireless communication to those containers located in the reach of the reader 16. The reader 16 may then achieve a short range communication with any or all of the devices 12 of the containers 10 that are transported on the rail line.

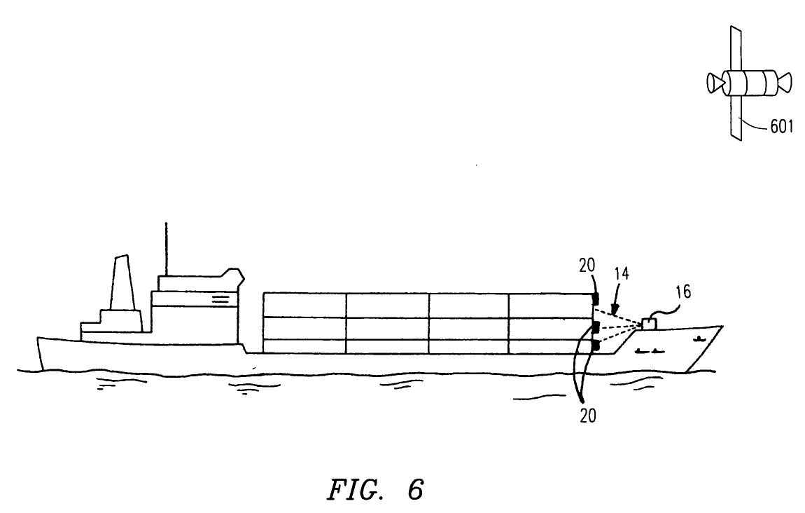

The same principles apply to a third application scenario for the container surveillance components, as shown in FIG. 6. Here, for each container to be identified, tracked, or monitored during sea transport, there must be provided a reader 16 in reach of the device 12 attached to the container 10. A first option would be to modify the loading scheme according to the attachment schemes for the wireless communication units. Alternatively, the distribution of the readers 16 over the container ship could be determined in accordance with a loading scheme being determined according to other constraints and parameters. Again, the flexible attachment/detachment of readers 16 for the surveillance of containers allows to avoid any fixed assets that would not generate revenues for the operator. In other words, once no more surveillance of containers is necessary, the reader 16 may easily be detached from the container ship and either be used on a different container ship or any other transporting device. The reader 16 may also be connected to the AIS, based on VHF communication, or Inmarsat satellites, both often used by shipping vessels.

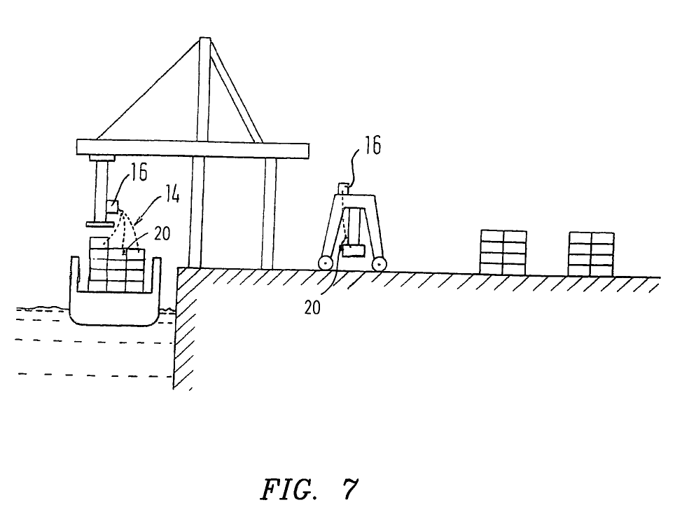

While above the application of the inventive surveillance components has been described with respect to long range global, regional or local transportation, in the following the application within a restricted area will be explained with respect to FIG. 7.

In particular, the splitting of the short range and long range wireless communication within a restricted area is applied to all vehicles and devices 12 handling the container 10 within the restricted area such as a container terminal, a container port, or a manufacturing site in any way. The restricted area includes in-gates and out-gates of such terminals and any kind of handling vehicles such as top-loaders, side-loaders, reach stackers, transtainers, hustlers, cranes, straddle carriers, etc.

A specific container is not typically searched for using only a single reader 16; rather, a plurality of readers 16 spread over the terminal and receive status and control information each time a container 10 is handled by, for example, a crane or a stacker. In other words, when a container passes a reader 16, the event is used to update related status and control information.

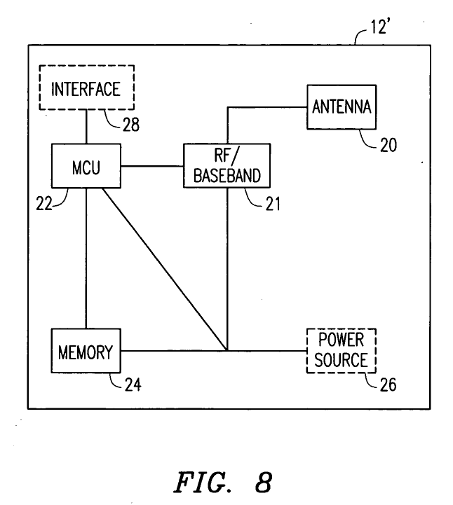

FIG. 8 illustrates a block diagram of a device 12′ in accordance with an embodiment of the present invention. The device 12′ includes an antenna 20, an RF/baseband unit 21, a microprocessor (MCU) 22, and a memory 24. The device 12′ may also include an interface 28 for attachment of additional sensors to monitor various internal conditions of the container such as, for example, temperature, vibration, radioactivity, gas, and motion. The device 12′ may also include an optional power source 26 (e.g., battery); however, other power arrangements that are detachable or remotely located may also be utilized by the device 12′.

The RF/baseband unit 21 and its antenna 20 are provided for wireless data exchange with the reader 16. In particular, various information, such as, for example, status and control data, may be exchanged. The microprocessor 22 may be programmed with a code that uniquely identifies the container 10 or cargo. The code may be, for example, an International Standards Organization (ISO) container identification code. The microprocessor 22 may also be programmed to implement power-management techniques. The microprocessor 22 may store other logistic data, such as Bill-of-Lading (B/L), a mechanical seal number, a reader identification with a time-stamp, etc. The code may also be transmitted from the device 12′ to the reader 16 for identification purposes. The RF/baseband unit 21 upconverts/downconverts microprocessor signals to and from baseband to RF for communication with the reader 16. The readers 16 may be located along the deck or cargo holds as deemed necessary or desirable to monitor movement of the cargo.

The device 12′ communicates with a reader 16 that may include an internal signal strength receiver for registering the Received Signal Strength Indicator (RSSI) value that enables cargo movements to be registered as a function of the relative and/or absolute change of the electromagnetic field, measured from different devices 12′ and/or different readers 16, or both. The devices 12′ and readers 16 may both use similar RF/baseband units and corresponding RSSI units. In another embodiment, the device 12′ and reader 16 may register the Time Of Arrival (TOA) of signals received by the antenna 20 in order determine if cargo movement has occurred. RSSI techniques utilize the magnitude (or amplitude) of the electromagnetic field strength, measure by either the reader 16 and/or the device 12′. TDOA techniques are used by wireless carriers of e.g. mobile telephony to locate wireless devices. In addition, Angle of Arrival (AOA), Location Pattern Matching (LPM) and GPS may be utilized to locate a wireless device, e.g., the reader 16 or the device 12′. Hybrid location techniques may be utilized that employ one or more technology, such as, for example, TDOA and AOA. The TDOA, AOA, and LPM techniques may be network based, whereas the GPS technique may be handset or wireless-device based. The RSSI value for each device 12′ and each reader 16 may be measured and monitored during shipment at selected time intervals or in response to user initiation. An alarm may be activated if the movement of a piece of cargo or a container exceeds a predetermined threshold. The devices 12′ may be logged at one or more of the readers 16 to determine the absolute positioning of the cargo as well as a directional vector (x, y, z, speed) of any moving cargo.

The device 12′ may be molded within a polyurethane material or the like in order to provide protection from the environment. The device 12′ may be mounted via a magnetic connection (as previously illustrated), an adhesive connection, or any other suitable connection, on the cargo or container 10. In the preferred embodiment, the device 12′ is mounted to the roof of a vehicle, however, the device 12′ may be mounted anywhere inside a vehicle, e.g., above the instrumentation panel/facia/dashboard, etc., as glass is RF transparent.

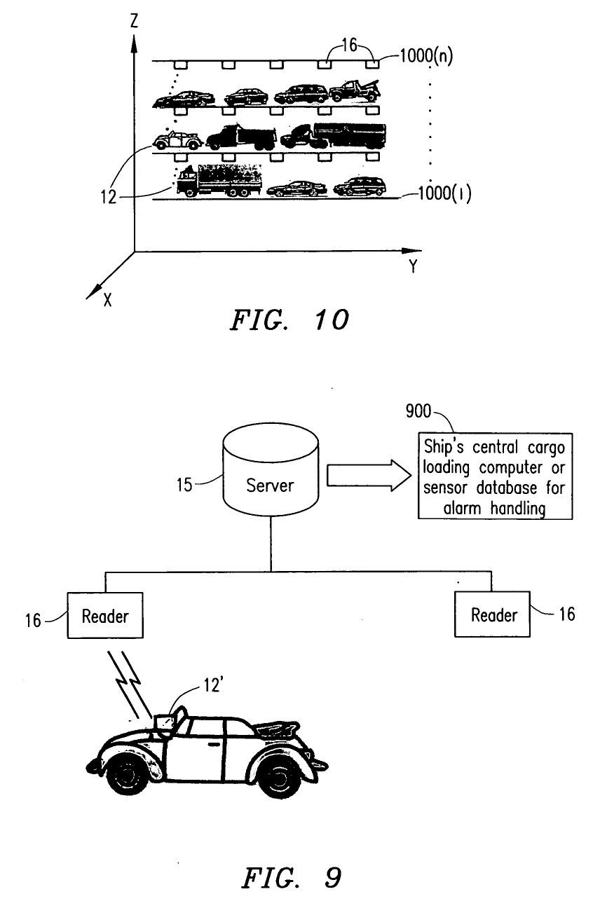

FIG. 9 illustrates a diagram of a device and reader in a shipping environment in accordance with an embodiment of the present invention. Prior to or at the vessel loading stage, the devices 12′ are affixed to a particular container 10 or other cargo such as, for example, a vehicle.

Information relating to the particular container or cargo to which the device 12′ is attached may be delivered to the device 12′. For example, a device identification, license plate number, weight, type of vehicle or cargo, etc. may be loaded into the device 12′ for storage. This information may be programmed into the device 12′ by the reader 16 prior to or at the loading of the vessel.

To create a baseline or reference of the cargo prior to possible shifting during shipment, the RSSI values for each device 12′ aboard the vessel may be cataloged and stored in a server 15. The RSSI values may be collected a number of times prior to shipping in order to create a more accurate baseline value. The server 15 may be utilized to create a data map of the environment of the shipping vessel prior to leaving the port. Once the cargo is en route, the stored data map may be compared to readings made at predetermined time intervals or at a user's initiation throughout the shipment. The location of the device 12′ may be transmitted continuously, periodically, or in response to an interrogation from a user. For example, a ship may experience harsh weather conditions and the captain may initiate location readings instantaneously or increase the frequency with which the measurements are taken. An alarm may be generated when the readings deviate beyond a predetermined threshold from the stored data map.

The reader 16 and the device 12′ are normally operating in a hierarchical star network topology and may send and receive signals during the shipment phase in order to determine the particular location of the devices 12′ affixed to cargo or containers 10. The devices may also send RSSI or TDOA information using autonomous so-called adhoc network functionality, i.e. being able to work and communicates in a topology were only the devices themselves communicate with one another, without a master (e.g., reader 16). The reader 16 receives position information from the device 12′ and transmits the information to the server 15. The position information may, for example, be RSSI information, TDOA information, etc . . . The reader 16 may transmit the identification number of the device 12′ and an estimated X-Y-Z position of the device 12′. An estimated direction of the cargo that is affixed with a device 12′ may be generated by the server 15. The device may also transmit information programmed into the device 12′ such as the license plate number, weight, etc. of the cargo. As mentioned above, if the estimated position of the device 12′ is beyond the predetermined threshold, then an alarm may be generated. The server 15 forwards information to an onboard computer system 900 that monitors cargo movement, and may also monitor other non-cargo environment conditions such as water tanks, smoke, fire, etc.

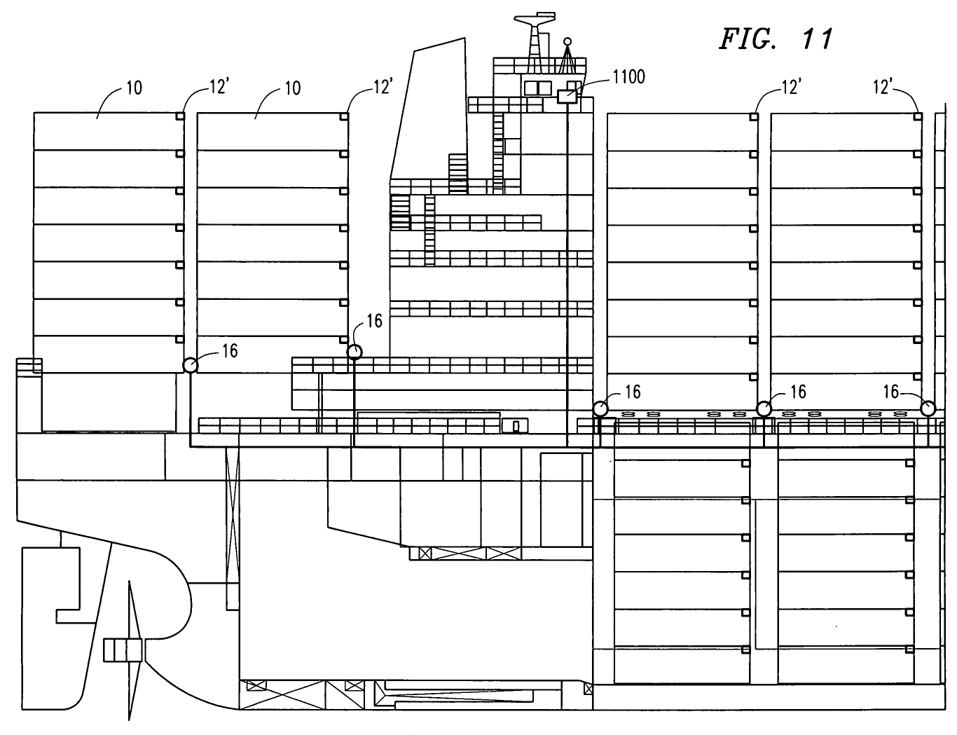

FIG. 10 is a diagram of a system in accordance with an embodiment of the present invention. As shown in FIG. 10, the vehicles or other cargo may be loaded onto decks 1000(1)-(n) of a shipping vessel. In another embodiment, cargo containers may be stacked in cargo holds or decks as illustrated in more detail in FIG. 11. If the cargo is placed on decks 1000(1)-(n), readers 16 may be placed throughout the respective roofs of the decks 1000(1)-(n) as needed or desired. A device 12′ is affixed to each piece of cargo so that RSSI values may be taken between the device 12′ and at least one reader 16. Tracking logic, while loading, i.e., monitoring the cargo as the cargo passes a series of readers 16 on a car-deck 1000(1)-(n), may also be utilized to give more reliable data. For example, the tracking logic may be used to verify the cargo manifest or track specific containers, e.g., explosives, etc.

FIG. 11 illustrates a diagram of a device and reader in a shipping environment in accordance with an embodiment of the present invention. In this embodiment, containers 10 are stacked along the deck of the ship and in cargo holds. Affixed to each container 10 is a device 12′ that communicates with readers 16 placed throughout the ship. An alarm 110, such as a visual or audio alarm, may be placed at, for example, the bridge of the ship in order to alert the captain or crew of movement of one or more of the containers 10 beyond a predetermined threshold.

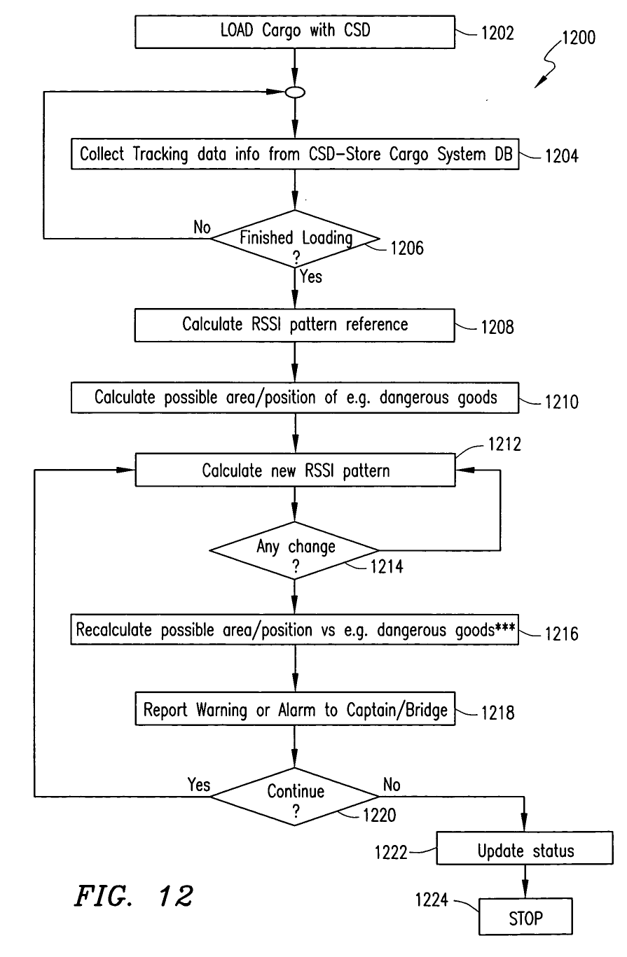

FIG. 12 illustrates a flow diagram of a method of monitoring movement of cargo of a shipping vessel in accordance with an embodiment of the present invention. At step 1202, the cargo or containers 10 are equipped with the device 12′ and loaded onto the shipping vessel. At step 1204, tracking data is collected from the device 12′ and stored in the database. For example, the tracking data may include identification, weight, length of the cargo, type of cargo, etc. If, at step 1206, the vessel has finished being loaded, then the process continues at step 1208. If the vessel has not been completely loaded, the process returns to step 1204 until the vessel is fully loaded. At step 1208, a data map of the shipping vessel is created to define a baseline for comparing any cargo movements. At step 1210, the position of dangerous goods is calculated. Step 1210 is not necessary for the implementation of embodiments of the present invention, however, the position of dangerous goods may prove valuable for the ship captain.

As mentioned above, at step 1212, new readings of the location of the devices 12′ may be taken at pre-set time intervals or at the initiation of a user. The location calculations may be done using raypath/range attenuation calculation, Nearest Neighbor Signal Strength (NNSS), or other positioning methods based on, for example, history data. NNSS techniques involve computing the Euclidean distance (in signal space) between each SS tuple (an ordered set of values) in the Radio Map (ss1, ss2, ss3) and the measured SS tuple (ss′1, ss′2, ss′3). NNSS then picks the SS tuple that minimizes the distance in signal space and declares the corresponding physical coordinates as its estimate of the user's location. Further information related to location calculation techniques may be found in Exhibit 1, entitled “A Software System for Locating Mobile Users: Design, Evaluation, and Lessons”, incorporated herein by reference, and Exhibit 2 entitled “RADAR: An RF Based In-Building User Location and Tracking System”, also incorporated herein by reference. Although NNSS has been utilized as a technique for performing location calculations, any History Based Algorithm (HBA) may be utilized in accordance with principles of the present invention. At step 1214, it is determined whether the new readings are outside of a predetermined threshold. If the readings are not outside the predetermined threshold, then the process loops back to step 1212. If the new readings are outside the predetermined threshold, then, at step 1216, the position of e.g., dangerous goods may be recalculated. Similarly to step 1210, step 1216 is not necessary for implementation of embodiments of the present invention. At step 1218, a warning or alarm is sent to the user, for example, at a bridge of the shipping vessel. At step 1220 the process may be continued by repeating step 1212, or the process may be stopped by continuing to step 1222. At step 1222, the status of the cargo and/or the current location of the cargo is updated and at step 1224 the process is ended.

Although the present invention is described in relation to device 12′, principles of the present invention may be incorporated into the device 12 without departing from the teachings of the present invention. In addition, although embodiment(s) of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the invention defined by the following claims.

What is claimed is:

1. A reader for monitoring the movement of cargo, the reader comprising:
means for transmitting and receiving information;
an internal signal receiver for receiving indicators, from a device, related to at least one of a position and a change in position of a particular piece of cargo to which the device is affixed; and
means for logging position-based data of the particular piece of cargo.

2. The reader of claim 1, wherein the internal signal receiver comprises an internal signal strength receiver for registering at least one received signal that indicates at least one of the position and the change in position of a particular piece of cargo.

3. The reader of claim 1, wherein the internal signal receiver comprises an internal time of arrival receiver for registering a time of arrival that indicates the position of a particular piece of cargo.

4. The reader of claim 1, further comprising means for transmitting measured Received Signal Strength Indicator (RSSI) or a Time Difference Of Arrival (TDOA) value of a particular piece of cargo to a server for calculation of the position or change in position.

5. The reader of claim 1, wherein the reader receives indicators from a plurality of devices affixed to a plurality of respective pieces of cargo.

6. The reader of claim 1, wherein the indicator represents an absolute position of the cargo.

7. The reader of claim 1, wherein the indicator represents a directional vector of the cargo.

8. The reader of claim 1, wherein the reader receives indicators at predetermined time intervals.

9. The reader of claim 1, wherein the reader is included in a system comprising a plurality of readers.

10. The reader of claim 1, wherein the reader is attached to a portion of an ocean-going vessel.

11. The reader of claim 1, wherein the reader is attached to a portion of a train.

12. The reader of claim 1, wherein the reader is oriented in a shipping yard.

13. The reader of claim 1, wherein the reader is oriented in a warehouse.

14. The reader of claim 1, wherein the reader is a second device and is included in an ad hoc network.

15. A server for monitoring movement of cargo, the server comprising:
means for storing a data map representing a position of each piece of cargo;
means for receiving indicators from at least one reader, said indicators representing a current position or directional vector for a particular piece of cargo; and
means for determining, based on the data map and the received indicators, whether a particular piece of cargo has moved beyond a predetermined threshold.

16. The server of claim 15, wherein if the particular piece of cargo has moved beyond the predetermined threshold, then an alarm is generated.

17. The server of claim 16, wherein the alarm is an audio alarm.

18. The server of claim 15, wherein the means for storing further comprises means for storing identification information for a particular piece of cargo.

19. The server of claim 18, wherein the identification information comprises at least one of a license plate number, weight, and type of cargo.

20. The server of claim 15, wherein the server receives indicators at predetermined time intervals.

21. A method of monitoring movement of cargo on a shipping vessel, the method comprising:
determining a data map, based on at least one of a Received Signal Strength Indicator (RSSI), a Time Difference Of Arrival (TDOA) value, and an Angle Of Arrival (AOA) value, including a position or change in position for each piece of cargo prior to moving the shipping vessel;
monitoring a position of each piece of cargo during movement of the shipping vessel; and
providing an alarm if a piece of cargo moves beyond a predetermined threshold.

22. The method of claim 21, wherein the method further comprises equipping each piece of cargo with a permanently-installed device.

23. The method of claim 22, wherein the method further comprises equipping each piece of cargo with a reusable, non-permanently-installed device.

24. The method of claim 22, wherein the step of monitoring further comprises:
receiving indicators from at least one device, the indicators for indicating a position or a directional vector of a particular piece of cargo; and
determining, based on the data map and the received indicators, whether a particular piece of cargo has moved.

25. The method of claim 21, wherein the step of determining a data map comprises calculating a position for each piece of cargo a plurality of times.

26. The method of claim 21, wherein the step of determining a data map comprises calculating the position or change in position by using at least one of raypath/range attenuation calculations, Nearest Neighbor Signal Strength (NNSS), and History Based Algorithms (HBA).
